(19) United States
(12) Patent Application Publication
(10) Pub. No.: US 2020/0404158 A1
(43) Pub. Date: Dec. 24, 2020

(54) ELECTRONIC DEVICE

(71) Applicant: CANON KABUSHIKI KAISHA, Tokyo (JP)

(72) Inventors: Tomoaki Takahashi, Isehara-shi (JP); Ryo Takahashi, Tokyo (JP); Ryu Wakui, Tokyo (JP); Asami Takenaga, Tokyo (JP)

(21) Appl. No.: 16/901,683

(22) Filed: Jun. 15, 2020

(30) Foreign Application Priority Data
Jun. 18, 2019 (JP) 2019-112662

(51) Int. Cl. H04N 5/232

(52) U.S. Cl. CPC H04N 5/23216; H04N 5/232933

(57) ABSTRACT

An electronic device controls so that before a specific touch operation, a first action is executed to change a specific target in a first direction and at a first speed according to continuation of touch, controls so that when the specific touch operation is performed in a second operation direction before the first action, according to the continuation after that, a second action is executed to change the specific target in a second direction which is opposite to the first direction, and at a second speed which is higher than the first speed, and controls so that when the specific touch operation is performed in the second operation direction during the first action, according to the continuation after that, a third action is executed to change the specific target in the second direction and at a third speed which is lower than the second speed.

### BACKGROUND OF THE INVENTION

### Field of the Invention

The present invention relates to a technique for changing a specific change target in response to a touch operation.

### Description of the Related Art

An image playback function for checking recorded images is conventionally installed in an imaging device such as a digital camera. With this image playback function, a user can check (view) a plurality of images while feeding from the displayed image to the next image or feeding (returning) to the previous image using an operating member or the like. Hereafter, this action will be referred to as image feeding.

When a large number of images are recorded, it may take a long time to retrieve a desired image. In order to feed through a large number of images quickly in such a case, a continuously rotatable rotary operating member may be installed. Using the rotary operating member, the user can feed through a plurality of images quickly by performing a quick rotation operation, the user can feed through the images while checking the images by performing a slow rotation operation, and the user can switch the feeding direction quickly by switching the direction of the rotation operation. As a result, the desired image can be retrieved efficiently. Due to recent reductions in the size and weight of devices, however, many devices cannot be installed with a rotary operating member.

Japanese Patent No. 6202777 discloses a technique for performing image feeding by switching classification data such as the date and time, the shooting location, and people in accordance with the direction of a sliding operation in order to retrieve a desired image from a large number of images efficiently (easily).

With the technique disclosed in Japanese Patent No. 6202777, however, it may take a long time to retrieve the desired image when a large number of images with the same classification data exist.

### SUMMARY OF THE INVENTION

The present invention provides an electronic device with which a specific change target can be changed to a desired target efficiently by performing a touch operation.

An electronic device according to the present invention includes: a touch detector configured to detect a touch operation performed on a touch operation surface; and at least one memory and at least one processor which function as: a control unit configured to control so that before a specific touch operation is performed on the touch operation surface, a first action is executed to change a specific change target in a first change direction and at a first speed in accordance with continuation of touch on the touch operation surface, control so that in a case where the specific touch operation is performed in a second operation direction before the first action is executed, in accordance with continuation of touch on the touch operation surface after that, a second action is executed to change the specific change target in a second change direction which is opposite to the first change direction, and at a second speed which is higher than the first speed, and control so that in a case where the specific touch operation is performed in the second operation direction during execution of the first action, in accordance with continuation of touch on the touch operation surface after that, a third action is executed to change the specific change target in the second change direction and at a third speed which is lower than the second speed.

Further features of the present invention will become apparent from the following description of exemplary embodiments with reference to the attached drawings.

### BRIEF DESCRIPTION OF THE DRAWINGS

FIGS. 1A and 1B are external views of a digital camera 100.

FIG. 2 is a block diagram of the digital camera 100.

FIG. 3 is a flowchart of image feeding processing.

FIG. 4 is a flowchart of touch-on midway processing.

FIGS. 5A to 5D are views showing how low-speed image feeding is performed.

FIGS. 6A to 6D are views showing how high-speed image feeding is performed.

FIG. 7 is a flowchart of leftward sliding operation processing.

FIG. 8 is a flowchart of rightward sliding operation processing.

FIG. 9 is a flowchart of touch-up processing.

### DESCRIPTION OF THE EMBODIMENTS

External Views of Digital Camera 100

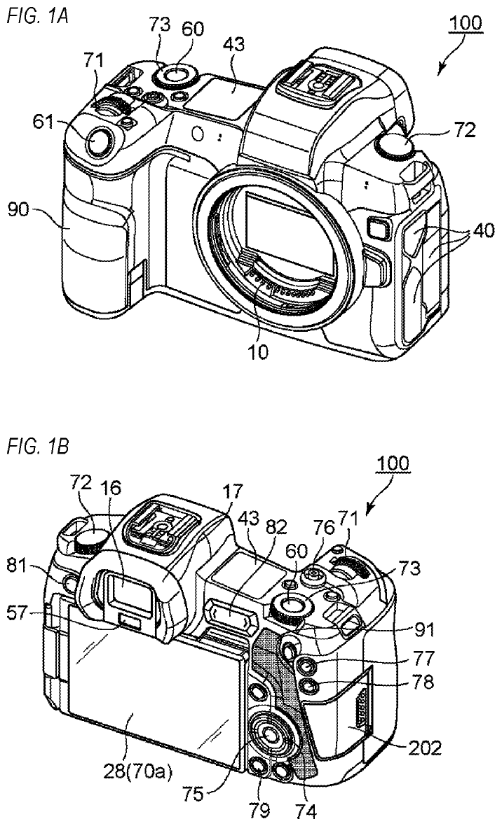

Preferred embodiments of the present invention will be described below with reference to the figures. FIGS. 1A and 1B are external views of a digital camera 100 serving as an example of an apparatus to which the present invention can be applied. FIG. 1A is a front perspective view of the digital camera 100, and FIG. 1B is a back perspective view of the digital camera 100.

A display unit 28 is provided on a back surface of the digital camera 100 in order to display images and various types of information. A touch panel 70a is capable of detecting touch operations performed on a display surface (a touch operation surface) of the display unit 28. A finder outer display unit 43 is provided on an upper surface of the digital camera 100 in order to display various setting values of the digital camera 100, such as the shutter speed and aperture. A shutter button 61 is an operating member for issuing shooting instructions. A mode switch 60 is an operating member for switching between various modes. A terminal cover 40 is a cover that protects a connector (not shown) for a connection cable or the like that connects the digital camera 100 to an external device.

A main electronic dial 71 is a rotary operating member, and by rotating the main electronic dial 71, setting values such as the shutter speed and the aperture can be changed and so on. A power supply switch 72 is an operating member for switching a power supply of the digital camera 100 ON and OFF. A sub-electronic dial 73 is a rotary operating member, and by rotating the sub-electronic dial 73, a selection frame (a cursor) can be moved, images can be fed, and so on. A four-direction keypad 74 is configured such that up, down, left, and right parts thereof can be pressed, whereby processing corresponding to the pressed part of the four-direction keypad 74 can be executed. A SET button 75 is a push-button used mainly to determine a selected item and so on.

A moving image button 76 is used to issue instructions to start and stop shooting (recording) a moving image. An AE lock button 77 is a push-button, and by pressing the AE lock button 77 in a shooting standby state, the exposure state can be fixed. A zoom button 78 is an operating button for switching a zoom mode ON and OFF during live view display (LV display) in a shooting mode. By operating the main electronic dial 71 after switching the zoom mode ON, the live view image (the LV image) can be enlarged and reduced. In a playback mode, the zoom button 78 functions as an operating button for enlarging the playback image and increasing the magnification ratio. A playback button 79 is an operating button for switching between the shooting mode and the playback mode. By pressing the playback button 79 in the shooting mode, the mode shifts to the playback mode, and as a result, the newest image among the images recorded on a recording medium 200 (described below) can be displayed on the display unit 28. A menu button 81 is a push-button used in an operation to issue an instruction to display a menu screen, and when the menu button 81 is pressed, a menu screen enabling various settings is displayed on the display unit 28. The user can perform various settings intuitively using the menu screen displayed on the display unit 28, the four-direction keypad 74, and a SET button 75.

A touch bar 82 (a multifunction bar: an M-Fn bar) is a linear touch operating member (a line touch sensor) capable of receiving touch operations. The touch bar 82 is positioned so that touch operations can be performed thereon (i.e. positioned to be touchable) by the thumb of a right hand gripping a grip portion 90 in a normal manner (the gripping manner recommended by the manufacturer). The touch bar 82 is a reception unit that can receive tap operations (an operation constituted by touching and then releasing within a predetermined time period without moving), leftward and rightward sliding operations (an operation constituted by touching and then moving the touch position while maintaining the touch), and the like on the touch bar 82. The touch bar 82 is a different operating member to the touch panel 70a and does not have a display function.

A communication terminal 10 is used by the digital camera 100 to communicate with a lens unit 150 (detachable; described below) side. An eyepiece portion 16 is the eyepiece portion of an eyepiece viewfinder 17 (a viewfinder that is looked through), and the user can view video displayed on an internal EVF 29 (described below) through the eyepiece portion 16. An eyepiece proximity detection unit 57 is an eyepiece proximity detection sensor for detecting whether or not the eye of the user (the photographer) is in proximity to the eyepiece portion 16. A cover 202 covers a slot housing the recording medium 200 (described below). The grip portion 90 is a holding portion shaped so that the user can easily grip the digital camera 100 with the right hand. When the digital camera 100 is held by gripping the grip portion 90 with the little finger, ring finger, and middle finger of the right hand, the shutter button 61 and the main electronic dial 71 are positioned to be operable by the index finger of the right hand. Further, in this state, the sub-electronic dial 73 and the touch bar 82 are positioned to be operable by the thumb of the right hand. A thumb rest 91 (a thumb standby position) is a grip member provided on the back surface side of the digital camera 100 in a location where the thumb of the right hand gripping the grip portion 90 can easily be placed when not operating any of the operating members. The thumb rest 91 is formed from a rubber member or the like to increase the holding force (the grip).

Block Diagram Illustrating Configuration of Digital Camera 100

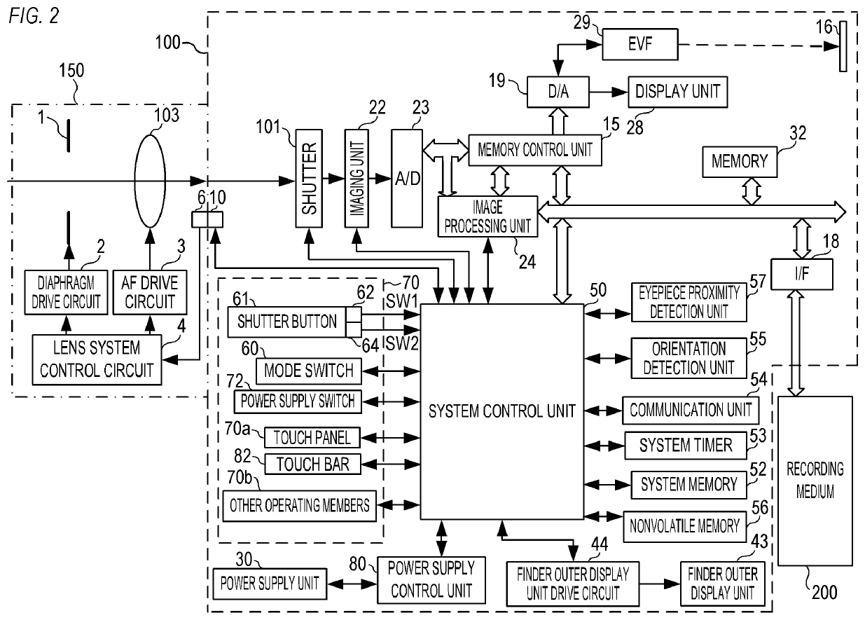

FIG. 2 is a block diagram showing an example configuration of the digital camera 100. Exchangeable shooting lenses are mounted in the lens unit 150. A lens 103 is usually constituted by a plurality of lenses, but for the sake of simplicity, only one lens is shown in FIG. 2. A communication terminal 6 is used by the lens unit 150 to communicate with the digital camera 100 side, while the communication terminal 10 is used by the digital camera 100 to communicate with the lens unit 150 side. The lens unit 150 communicates with a system control unit 50 via the communication terminals 6 and 10. Further, in the lens unit 150, a diaphragm 1 is controlled by an internal lens system control circuit 4 via a diaphragm drive circuit 2. Furthermore, in the lens unit 150, focusing is performed by the lens system control circuit 4 by changing the position of the lens 103 via an AF drive circuit 3.

A shutter 101 is a focal plane shutter that can freely control the exposure time of an imaging unit 22 under the control of the system control unit 50.

The imaging unit 22 is an imaging device constituted by a CCD, a CMOS device, or the like that converts optical images into electrical signals. The imaging unit 22 may include an image plane phase difference sensor for outputting defocus amount information to the system control unit 50. An A/D converter 23 converts analog signals output from the imaging unit 22 into digital signals.

An image processing unit 24 performs predetermined processing (pixel interpolation, resizing processing such as reduction, color conversion processing, and so on) on data from the A/D converter 23 and data from a memory control unit 15. Further, the image processing unit 24 performs predetermined calculation processing using captured image data, and the system control unit 50 performs exposure control and range-finding control on the basis of calculation results acquired by the image processing unit 24. Thus, through-the-lens (TTL) type autofocus (AF) processing, automatic exposure (AE) processing, flash pre-emission (EF) processing, and so on are performed. The image processing unit 24 also performs predetermined calculation processing using the captured image data and performs TTL type automatic white balance (AWB) processing on the basis of the acquired calculation results.

Output data from the A/D converter 23 are written to a memory 32 via the image processing unit 24 and the memory control unit 15. Alternatively, the output data from the A/D converter 23 are written to the memory 32 via the memory control unit 15 without passing through the image processing unit 24. The memory 32 stores image data acquired by the imaging unit 22 and converted into digital data by the A/D converter 23, and image data to be displayed on the display unit 28 or the EVF 29. The memory 32 has enough storage capacity to store a predetermined number of static images or moving images and audio of a predetermined length.

The memory 32 doubles as an image display memory (a video memory). A D/A converter 19 converts image display data stored in the memory 32 into analog signals and supplies the analog signals to the display unit 28 and the EVF 29. Thus, display image data written to the memory 32 are displayed by the display unit 28 or the EVF 29 via the D/A converter 19. The display unit 28 and the EVF 29 each perform display corresponding to analog signals from the D/A converter 19 on a display such as an LCD or an organic EL display. Live view (LV) display can be performed by converting digital signals performed to A/D conversion by the A/D converter 23 and stored in the memory 32 into analog signals in the D/A converter 19 and transferring the converted analog signals successively to the display unit 28 or the EVF 29 to be displayed thereon. An image displayed by live view display will be referred to hereafter as a live view image (an LV image).

Various setting values of the camera, such as the shutter speed and the aperture, are displayed on the finder outer display unit 43 via a finder outer display unit drive circuit 44.

A nonvolatile memory 56 is an electrically erasable/recordable memory such as an EEPROM, for example. Constants, programs, and so on used in the actions of the system control unit 50 are recorded in the nonvolatile memory 56. Here, the programs refer to programs used to execute various flowcharts according to this embodiment, to be described below.

The system control unit 50 is a control unit constituted by at least one processor or circuit in order to perform overall control of the digital camera 100. The system control unit 50 realizes the respective processes of this embodiment, to be described below, by executing the programs stored in the nonvolatile memory 56, as described above. A system memory 52 is constituted by a RAM, for example, and the system control unit 50 expands the constants and variables used in the actions of the system control unit 50, the programs read from the nonvolatile memory 56, and so on in the system memory 52. The system control unit 50 also performs display control by controlling the memory 32, the D/A converter 19, the display unit 28, and so on.

A system timer 53 is a clock unit that measures the time used to perform various types of control and the time on an inbuilt clock.

A power supply control unit 80 is constituted by a battery detection circuit, a DC-DC converter, a switch circuit for switching a conductive block, and so on, and the power supply control unit 80 detects whether or not a battery is attached, the type of battery, the remaining battery charge, and so on. Further, the power supply control unit 80 controls the DC-DC converter on the basis of the detection results acquired thereby and an instruction from the system control unit 50 and supplies a required voltage to parts including the recording medium 200 for a required period. A power supply unit 30 is constituted by a primary battery such as an alkali battery or a lithium battery, a secondary battery such as an NiCd battery, an NiMH battery, or an Li battery, an AC adapter, or the like.

A recording medium I/F 18 is an interface with the recording medium 200, which is a memory card, a hard disk, or the like. The recording medium 200 is a memory card or the like for recording photographed images, and is formed from a semiconductor memory, a magnetic disk, or the like.

A communication unit 54 exchanges video signals and audio signals with an external device connected either wirelessly or by cable. The communication unit 54 can also be connected to a wireless local area network (LAN) or the Internet. The communication unit 54 can also communicate with the external device by Bluetooth® or Bluetooth® Low Energy. The communication unit 54 is capable of transmitting images (including LV images) captured by the imaging unit 22 and images recorded in the recording medium 200 and receiving image data and various other types of information from the external device.

An orientation detection unit 55 detects the orientation of the digital camera 100 relative to the direction of gravity. On the basis of the orientation detected by the orientation detection unit 55, it is possible to determine whether an image taken by the imaging unit 22 is an image taken with the digital camera 100 held horizontally or an image taken with the digital camera 100 held vertically. The system control unit 50 is capable of attaching orientation information corresponding to the orientation detected by the orientation detection unit 55 to an image file of an image taken by the imaging unit 22, rotating the image, and recording the rotated image. An acceleration sensor, a gyro sensor, or the like can be used as the orientation detection unit 55. Movement of the digital camera 100 (panning, tilting, raising, whether or not the digital camera 100 is stationary, and so on) can also be detected using the acceleration sensor or gyro sensor serving as the orientation detection unit 55.

The eyepiece proximity detection unit 57 is an eyepiece proximity detection sensor for detecting movement of the eye (an object) toward (eyepiece proximity) and away from (eyepiece separation) the eyepiece portion 16 of the eyepiece viewfinder 17 (referred to simply as “the viewfinder” hereafter) (i.e. performing eyepiece proximity detection). The system control unit 50 switches the display unit 28 and the EVF 29 between display (a display state) and non-display (a non-display state) in accordance with the state detected by the eyepiece proximity detection unit 57. More specifically, at least in the shooting standby state, and in a case where display destination switching is set at automatic switching, when the eye is not in proximity, the display unit 28 is set as the display destination and switched ON while the EVF 29 is switched OFF. Further, when the eye is in proximity, the EVF 29 is set as the display destination and switched ON while the display unit 28 is switched OFF. An infrared proximity sensor, for example, can be used as the eyepiece proximity detection unit 57, and the eyepiece proximity detection unit 57 is capable of detecting the approach of any object toward the eyepiece portion 16 of the viewfinder 17 having the inbuilt EVF 29. When an object approaches, infrared rays emitted from a light-emitting portion (not shown) of the eyepiece proximity detection unit 57 are reflected by the object and received by a light-receiving portion (not shown) of the infrared proximity sensor. The distance of the object from the eyepiece portion 16 (the eyepiece distance) can also be determined from the amount of received infrared rays. Thus, the eyepiece proximity detection unit 57 performs eyepiece proximity detection to detect the distance of the object from the eyepiece portion 16. When an approaching object that is within a predetermined distance of the eyepiece portion 16 is detected from a state of eyepiece non-proximity (a non-proximal state), eyepiece proximity is detected. When the detected approaching object moves at least a predetermined distance away from a state of eyepiece proximity (a proximal state), separation from the eyepiece is detected. A threshold for detecting eyepiece proximity and a threshold for detecting eyepiece separation may be set to be different by providing hysteresis or the like, for example. Further, after eyepiece proximity is detected, the state of eyepiece proximity remains established until eyepiece separation is detected. After eyepiece separation is detected, the state of eyepiece non-proximity remains established until eyepiece proximity is detected. Note that an infrared proximity sensor is merely an example, and any other sensor capable of detecting the approach of an eye or an object as eyepiece proximity may be used as the eyepiece proximity detection unit 57.

An operating unit 70 is an input unit for receiving operations from the user (user operations) and is used to input various action instructions to the system control unit 50. As shown in FIG. 2, the operating unit 70 includes the mode switch 60, the shutter button 61, the power supply switch 72, the touch panel 70a, the touch bar 82, and so on. Further, as other operating members 70b, the operating unit 70 includes the main electronic dial 71, the sub-electronic dial 73, the four-direction keypad 74, the SET button 75, the moving image button 76, the AE lock button 77, the zoom button 78, the playback button 79, the menu button 81, and so on.

The mode switch 60 switches the action mode of the system control unit 50 to one of a static image shooting mode, the moving image shooting mode, the playback mode, and so on. Modes included in the static image shooting mode include an automatic shooting mode, an automatic scene determination mode, a manual mode, an aperture priority mode (an Av mode), a shutter speed priority mode (a Tv mode), and a programmable AE mode (a P mode). Various scene modes, custom modes, and so on are also provided as shooting settings for different shooting scenes. The user can switch directly to any one of these modes using the mode switch 60. Alternatively, the mode switch 60 may be used to switch temporarily to a shooting mode list screen, whereupon the operating mode can be switched selectively to one of the plurality of displayed modes using another operating member. Similarly, the moving image shooting mode may also include a plurality of modes.

The shutter button 61 includes a first shutter switch 62 and a second shutter switch 64. The first shutter switch 62 switches ON midway through an operation of the shutter button 61, i.e. in a so-called half-pressed state (a shooting preparation instruction), thereby generating a first shutter switch signal SW1. In response to the first shutter switch signal SW1, the system control unit 50 starts shooting preparation actions such as autofocus (AF) processing, automatic exposure (AE) processing, automatic white balance (AWB) processing, and flash pre-emission (EF) processing. The second shutter switch 64 switches ON when the operation of the shutter button 61 is complete, i.e. in a so-called fully pressed state (a shooting instruction), thereby generating a second shutter switch signal SW2. In response to the second shutter switch signal SW2, the system control unit 50 starts a series of shooting processing actions from reading a signal from the imaging unit 22 to writing a captured image to the recording medium 200 in the form of an image file.

The touch panel 70a and the display unit 28 may be formed integrally. For example, the touch panel 70a is configured to have a light transmittance that does not impede the display on the display unit 28 and is attached to an upper layer of the display surface of the display unit 28. Coordinates input into the touch panel 70a are associated with display coordinates on the display surface of the display unit 28. Thus, it is possible to provide a graphical user interface (GUI) giving the impression that the user can directly operate a screen displayed on the display unit 28. The system control unit 50 is capable of detecting the following operations or states on the touch panel 70a.
A finger or a pen not touching the touch panel 70a newly touches the touch panel 70a, or in other words, a touch is started (referred to hereafter as a touch-down).
A finger or pen is touching the touch panel 70a (referred to hereafter as a touch-on).
A finger or pen is moved while touching the touch panel 70a (referred to hereafter as a touch-move).
A finger or pen touching the touch panel 70a is removed (released) from the touch panel 70a, or in other words, a touch is terminated (referred to hereafter as a touch-up).
Nothing is touching the touch panel 70a (referred to hereafter as a touch-off).

When a touch-down is detected, a touch-on is detected at the same time. In a normal state, a touch-on continues to be detected following a touch-down until a touch-up is detected. A touch-on is also detected at the same time as a touch-move is detected. Even when a touch-on is detected, a touch-move is not detected unless the touch position moves. After it is detected that all touching fingers and pens have performed a touch-up, a touch-off is detected.

The system control unit 50 is notified of these operations and states, as well as the coordinates of the position in which the finger or pen is touching the touch panel 70a, via an internal bus, and on the basis of the information of which the system control unit 50 is notified, the system control unit 50 determines the nature of the operation (the touch operation) performed on the touch panel 70a. The movement direction of the finger or pen moving over the touch panel 70a during a touch-move can be determined for each vertical component and each horizontal component on the touch panel 70a on the basis of variation in the position coordinates. When a touch-move of at least a predetermined distance is detected, a sliding operation is determined to have been performed. An operation for moving a finger over the touch panel 70a quickly for a certain distance while touching the touch panel 70a and then removing the finger is known as a flick. In other words, a flick is an operation for quickly stroking the touch panel 70a with a finger in a flicking motion. When a touch-move of at least a predetermined speed is detected over at least a predetermined distance and the touch-move is followed by a touch-up, it can be determined that a flick has been performed (a flick can be determined to have been performed following a sliding operation). Furthermore, a touch operation in which a plurality of locations (two points, for example) are touched together (multi-touched) and then the touch positions are brought closer together is known as a pinch-in, while a touch operation in which the touch positions are moved further away from each other is known as a pinch-out. A pinch-out and a pinch-in are referred to collectively as a pinching operation (or simply a pinch). The touch panel 70a may use any of various systems, such as a resistive film system, an electrostatic capacitance system, a display acoustic wave system, an infrared system, an electromagnetic induction system, an image recognition system, or an optical sensor system. Either a system that detects contact with the touch panel as a touch or a system that detects the approach of a finger or a pen toward the touch panel as a touch may be used.

The system control unit 50 is also capable of detecting the following operations or states on the touch bar 82.
A finger not touching the touch bar 82 newly touches the touch bar 82, or in other words, a touch is started (referred to hereafter as a touch-down).
A finger is touching the touch bar 82 (referred to hereafter as a touch-on).
A finger is moved while touching the touch bar 82 (referred to hereafter as a touch-move).
A finger touching the touch bar 82 is removed (released) from the touch bar 82, or in other words, a touch is terminated (referred to hereafter as a touch-up).
Nothing is touching the touch bar 82 (referred to hereafter as a touch-off).

When a touch-down is detected, a touch-on is detected at the same time. In a normal state, a touch-on continues to be detected following a touch-down until a touch-up is detected. A touch-on is also detected at the same time as a touch-move is detected. Even when a touch-on is detected, a touch-move is not detected unless the touch position moves. After it is detected that all touching fingers and pens have performed a touch-up, a touch-off is detected.

The system control unit 50 is notified of these operations and states, as well as the coordinates of the position in which the finger is touching the touch bar 82, via an internal bus, and on the basis of the information of which the system control unit 50 is notified, the system control unit 50 determines the nature of the operation (the touch operation) performed on the touch bar 82. During a touch-move, movement over the touch bar 82 in a horizontal direction (a left-right direction) is detected. When movement of the touch position by at least a predetermined distance (movement of at least a predetermined amount) is detected, a sliding operation is determined to have been performed. When an operation for touching the touch bar 82 with a finger and releasing the touch within a predetermined time without performing a sliding operation is performed, a tap operation is determined to have been performed. In this embodiment, the touch bar 82 is an electrostatic capacitance type touch sensor. However, touch sensors using various other systems, such as a resistive film system, a display acoustic wave system, an infrared system, an electromagnetic induction system, an image recognition system, or an optical sensor system, may be used instead.

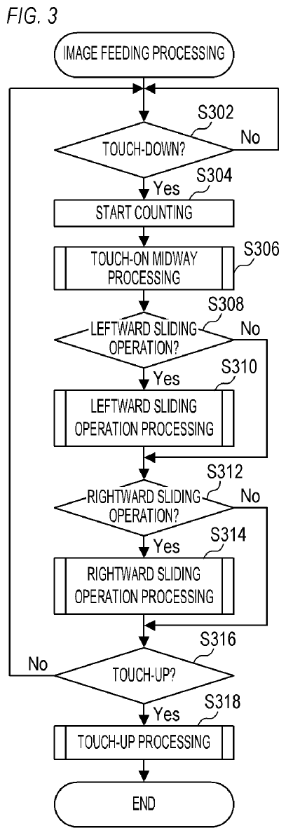

FIG. 3 is a flowchart showing image feeding processing performed by the digital camera 100 in detail. This processing is realized by the system control unit 50 by expanding a program recorded in the nonvolatile memory 56 in the system memory 52 and executing the program. When the operating mode is switched to the playback mode using the playback button 79, one of the plurality of images recorded in the recording medium 200 is displayed on the display unit 28, whereupon the processing of FIG. 3 is started.

In S302, the system control unit 50 determines whether or not a touch-down has been performed on the touch bar 82 on the basis of output information from the touch bar 82. When a touch-down has been performed, the processing advances to S304, and when a touch-down has not been performed, the system control unit 50 waits for a touch-down to be performed.

In S304, the system control unit 50 starts to count time in order to determine whether or not to start continuous image feeding (continuously switching the displayed image among a plurality of images). Hereafter, the counted time will be referred to as the touch count time.

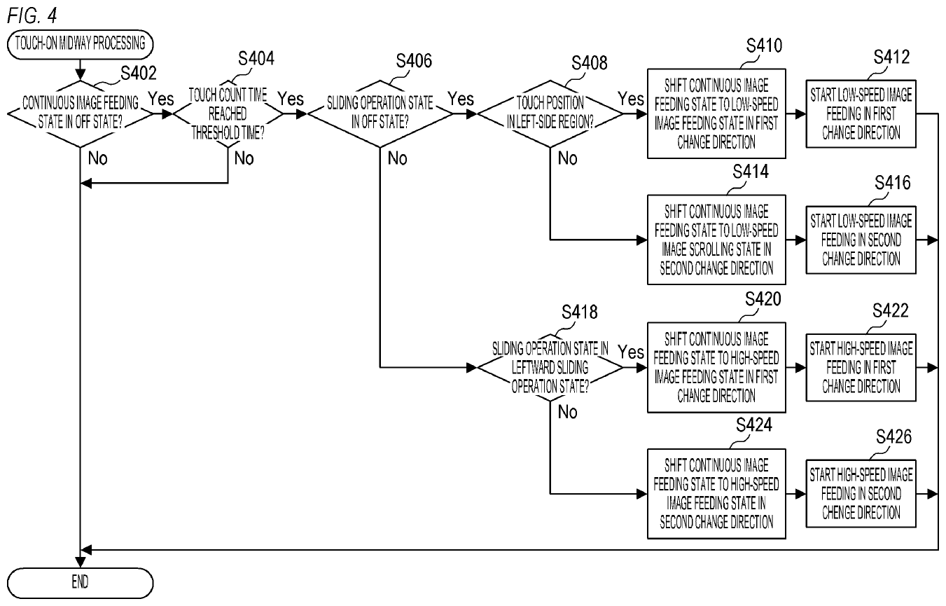

In S306, the system control unit 50 performs touch-on midway processing. The touch-on midway processing will be described in detail below using FIG. 4.

In S308, the system control unit 50 determines whether or not a leftward direction (a first operation direction) sliding operation has been performed on the touch bar 82 on the basis of the output information from the touch bar 82. When a leftward sliding operation has been performed, the processing advances to S310, and when a leftward sliding operation has not been performed, the processing advances to S312.

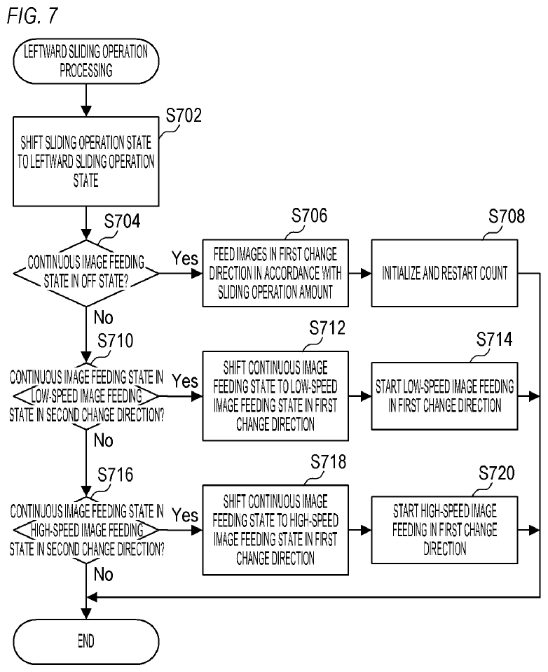

In S310, the system control unit 50 performs leftward sliding operation processing. The leftward siding operation processing will be described in detail below using FIG. 7.

In S312, the system control unit 50 determines whether or not a rightward direction (a second operation direction) sliding operation has been performed on the touch bar 82 on the basis of the output information from the touch bar 82. When a rightward sliding operation has been performed, the processing advances to S314, and when a rightward sliding operation has not been performed, the processing advances to S316.

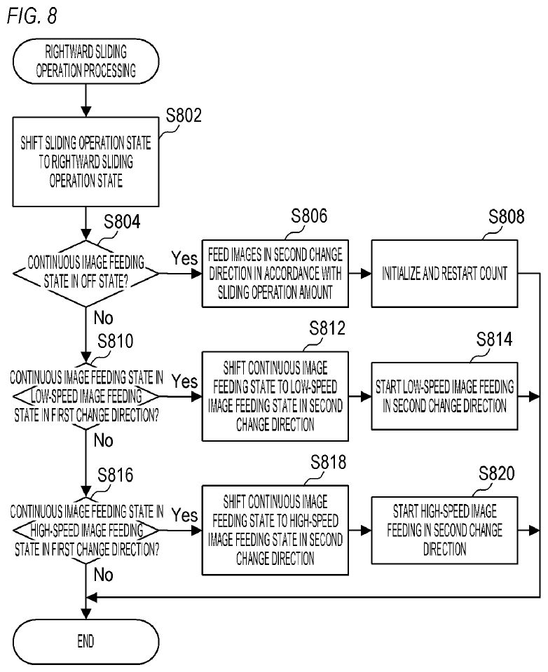

In S314, the system control unit 50 performs rightward sliding operation processing. The rightward siding operation processing will be described in detail below using FIG. 8.

In S316, the system control unit 50 determines whether or not a touch-up has been performed from the touch bar 82 on the basis of the output information from the touch bar 82. When a touch-up has been performed, the processing advances to S318, and when a touch-up has not been performed, the processing advances to S302.

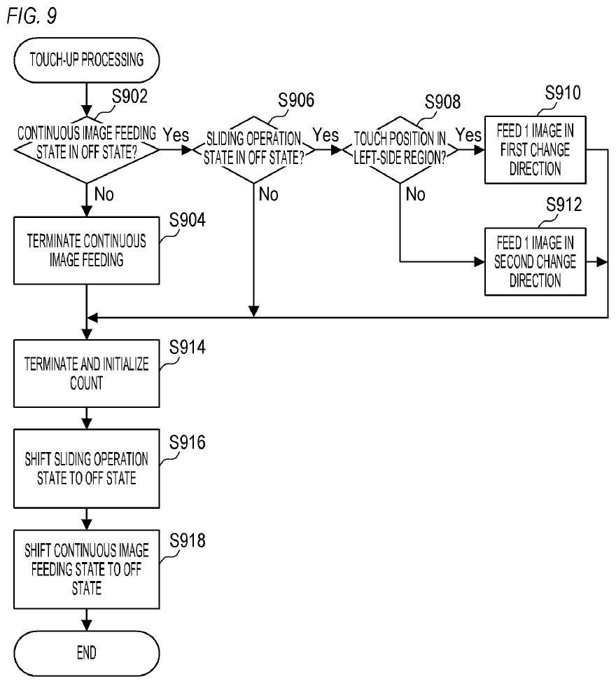

In S318, the system control unit 50 performs touch-up processing. The touch-up processing will be described in detail below using FIG. 9.

FIG. 4 is a flowchart showing the touch-on midway processing (S306 in FIG. 3) performed by the digital camera 100 in detail. This processing is realized by the system control unit 50 by expanding a program recorded in the nonvolatile memory 56 in the system memory 52 and executing the program.

In S402, the system control unit 50 determines whether or not a continuous image feeding state (a flag) is in an OFF state. When the continuous image feeding state is in the OFF state, this means that continuous image feeding is not underway. For example, the continuous image feeding state is in the OFF state at the start of the image feeding processing (FIG. 3). When the continuous image feeding state is in the OFF state, the processing advances to S404, and when the continuous image feeding state is not in the OFF state, the touch-on midway processing is terminated.

In S404, the system control unit 50 determines whether or not the touch count time, counting of which was started in S304 of FIG. 3 or the like, has reached a threshold time. When the touch count time has reached the threshold time, this means that the touch bar 82 is being touched without a touch-move (i.e. in a stationary manner). When the touch count time has reached the threshold time, the processing advances to S406, and when the touch count time has not reached the threshold time, the touch-on midway processing is terminated. In this embodiment, the threshold time is 1 second, and at the point where the touch count time reaches 1 second, a single image switch (or an image switch of a minimum image feeding unit when the continuous image feeding state is established at the point where the touch count time reaches 1 second) is performed.

In S406, the system control unit 50 determines whether or not a sliding operation state (a flag) is in an OFF state. When the sliding operation state is in the OFF state, this means that a sliding operation has not yet been performed on the touch bar 82. For example, the sliding operation state is in the OFF state at the start of the image feeding processing (FIG. 3). When the sliding operation state is in the OFF state, the processing advances to S408, and when the sliding operation state is not in the OFF state, the processing advances to S418.

In S408, the system control unit 50 determines whether or not the touch position on the touch bar 82 is in a left-side region (a predetermined region on the left side of the touch operation screen of the touch bar 82). When the touch position is in the left-side region, the processing advances to S410, and when the touch position is not in the left-side region (when the touch position is in a right-side region (a predetermined region further toward the right side of the touch operation screen of the touch bar 82 than the left-side region)), the processing advances to S414.

In S410, the system control unit 50 shifts (switches) the continuous image feeding state to a low-speed image feeding state in a first change direction (an image returning direction, a decreasing direction, an opposite direction). The low-speed image feeding state in the first change direction is a state in which low-speed image feeding is performed in a first change direction (as described below).

In S412, the system control unit 50 performs low-speed image feeding in the first change direction. Low-speed image feeding in the first change direction is an action for switching the image displayed on the display unit 28 between a plurality of images in the first change direction and at a first speed (a lower speed than a second speed to be described below). In this embodiment, during image switching at the first speed, 1 image is switched every 0.5 seconds (the images are fed at 2 images per second). Further, in this embodiment, during image switching at the second speed, 1 image is switched every ⅙ of a second (the images are fed at 6 images per second).

In S414, the system control unit 50 shifts the continuous image feeding state to a low-speed image feeding state in a second change direction (an image feeding direction, an increasing direction, a forward direction). The low-speed image feeding state in the second change direction is a state in which low-speed image feeding is performed in a second change direction (as described below).

In S416, the system control unit 50 performs low-speed image feeding in the second change direction. Low-speed image feeding in the second change direction is an action for switching the image displayed on the display unit 28 between a plurality of images in the second change direction and at the first speed.

Hence, by executing the touch-on midway processing of FIG. 4, low-speed image feeding is performed in either the first change direction or the second change direction in accordance with the continuation of the touch before a sliding operation is performed on the touch bar 82 (in other words, in a state where a touch-move has not been performed after a touch-down).

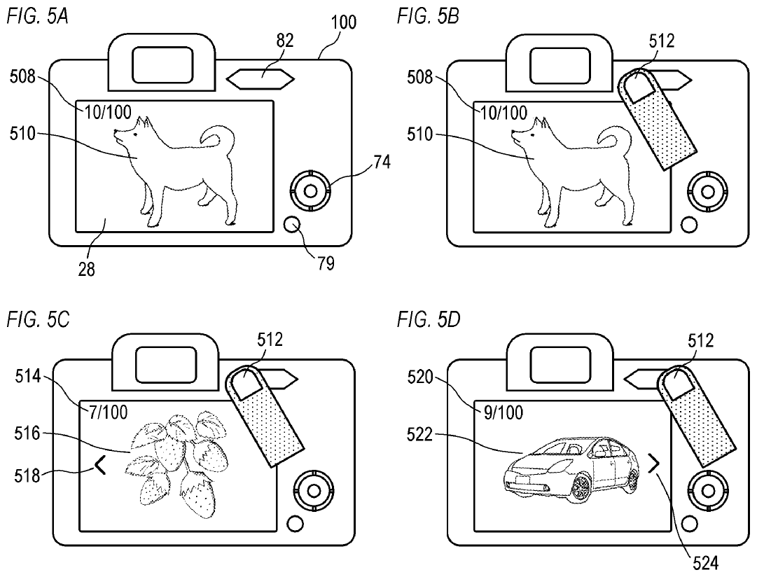

Using FIGS. 5A to 5C, an example of how low-speed image feeding is performed in the first change direction will be described. FIGS. 5A to 5C and FIG. 5D, to be described below, show examples of screens displayed on the display unit 28 in the playback mode.

FIG. 5A shows a state in which a touch operation has not been performed on the touch bar 82. In FIG. 5A, an image 510 and image number information 508 are displayed on the display unit 28. The image number information 508 indicates that a total of 100 images (image files) are stored in the recording medium 200 and that the image 510 is the image of a 10^{th} image file. In this embodiment, the images are arranged in order of the file numbers of the images (in file name order), but the images may be arranged in a different order such as shooting date order or update date order.

FIG. 5B shows a state immediately after a touch-down has been performed in the left-side region of the touch bar 82 by a finger 512 from the state shown in FIG. 5A. When the touch count time reaches the threshold time in the state shown in FIG. 5B (when the touch is continued for the threshold time without performing a sliding operation), low-speed image feeding in the first change direction (S412 in FIG. 4) is performed.

FIG. 5C shows a state at the point where the touch in the left-side region of the touch bar 82 has continued for 2 seconds from the state shown in FIG. 5B. In this embodiment, when a touch continues for 1 second in the left-side region so that the touch count time reaches the threshold time (1 second), the displayed image is returned to the preceding image. Thereafter, when the touch is continued in the left-side region, the displayed image is returned to the preceding image every 0.5 seconds (low-speed image feeding in the first change direction). In FIG. 5C, therefore, an image 516 of an image file three files (=1 image+1 image×1 second/0.5 seconds) before the image 510 is displayed on the display unit 28. Image number information 514 and feeding information 518 are also displayed on the display unit 28. The image number information 514 indicates that the image 516 is the 7^{th} image file. The feeding information 518 is a display item showing the current direction and speed of the image feeding, in which the first change direction (a direction for returning the displayed image to the previous image) is indicated by a position and a direction and the first speed (low speed) is indicated by a pattern.

In S418, the system control unit 50 determines whether or not the sliding operation state is in a leftward sliding operation state. The leftward sliding operation state is established after a leftward sliding operation is performed on the touch bar 82. When the sliding operation state is in the leftward sliding operation state, the processing advances to S420, and when sliding operation state is not in the leftward sliding operation state, the processing advances to S424.

In S420, the system control unit 50 shifts the continuous image feeding state to a high-speed image feeding state in the first change direction. The high-speed image feeding state in the first change direction is a state in which high-speed image feeding (described below) is performed in the first change direction.

In S422, the system control unit 50 performs high-speed image feeding in the first change direction. High-speed image feeding in the first change direction is an action for switching the image displayed on the display unit 28 between a plurality of images in the first change direction and at the second speed (a higher speed than the first speed, as described above). In this embodiment, as described above, image switching at the second speed is realized by switching 1 image every ⅙ of a second (feeding the images at 6 images per second).

In S424, the system control unit 50 shifts the continuous image feeding state to a high-speed feeding state in the second change direction. The high-speed image feeding state in the second change direction is a state in which high-speed image feeding is performed in the second change direction (as described below).

In S426, the system control unit 50 performs high-speed image feeding in the second change direction. High-speed image feeding in the second change direction is an action for switching the image displayed on the display unit 28 between a plurality of images in the second change direction and at the second speed.

Hence, according to the touch-on midway processing of FIG. 4, after a sliding operation is performed on the touch bar 82 (in other words, when a touch-move is performed within the threshold time after a touch-down, after which the touch remains stationary) before low-speed image feeding is executed, high-speed image feeding is performed in the first change direction or the second change direction in accordance with the continuation of the touch. As described above, before the sliding operation is performed on the touch bar 82, low-speed image feeding is performed in the first change direction or the second change direction in accordance with the continuation of the touch. As a result, the user can easily change the speed of the continuous image feeding using a touch operation and thereby efficiently retrieve a desired image.

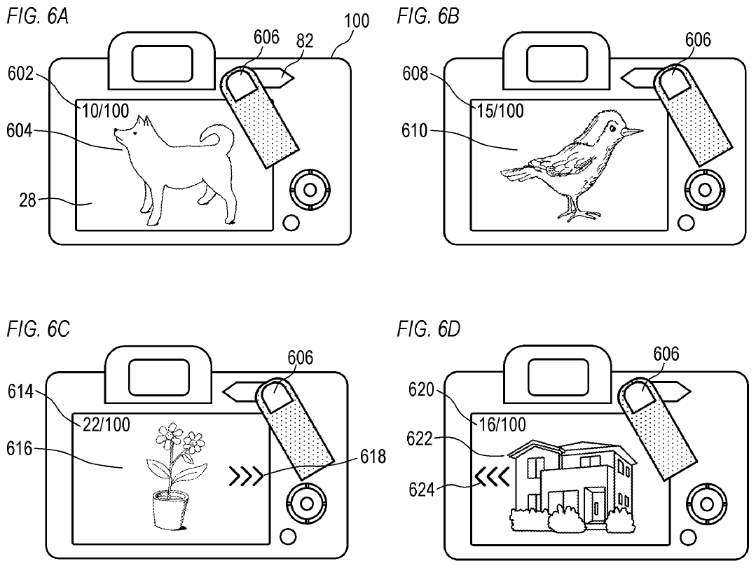

Using FIGS. 6A to 6C, an example of how high-speed image feeding is performed in the second change direction will be described. FIGS. 6A to 6C and FIG. 6D, to be described below, show examples of screens displayed on the display unit 28 in the playback mode.

FIG. 6A shows a state immediately after a touch-down is performed in the left-side region of the touch bar 82 when continuous image feeding is not underway. In FIG. 6A, an image 604 and image number information 602 are displayed on the display unit 28, and the left-side region of the touch bar 82 is being touched by a finger 606. The image number information 602 indicates that the image 604 is the 10^{th} image. When the finger 606 performs a rightward sliding operation from the state shown in FIG. 6A, the displayed image is changed in the second change direction by a number of images corresponding to the sliding operation amount (the operation amount of the sliding operation; the amount by which the touch position is moved during the sliding operation) (processing of S706, to be described below).

FIG. 6B shows a state immediately after a rightward sliding operation for moving the finger 606 to the right-side region of the touch bar 82 from the state shown in FIG. 6A. In FIG. 6B, a fifth image 610 after the image 604 is displayed on the display unit 28 as a result of image feeding performed in the second change direction in accordance with the sliding operation amount. Image number information 608 indicating that the image 610 is the image of the 15^{th} image file is also displayed on the display unit 28. When the touch count time reaches the threshold time in the state shown in FIG. 6B, high-speed image feeding is performed in the second change direction (S426 in FIG. 4).

FIG. 6C shows a state at the point where the touch in the right-side region of the touch bar 82 has continued for 2 seconds from the state shown in FIG. 6B. In this embodiment, when a touch continues for 1 second in the right-side region so that the touch count time reaches the threshold time (1 second), the displayed image is fed to the following image. Thereafter, when the touch is continued in the right-side region, the displayed image is fed to the following image every ⅙ of a second (high-speed image feeding in the second change direction). In FIG. 6C, therefore, a seventh image 616 (=1 image+1 image×1 second/(⅙ of a second)) after the image 610 is displayed on the display unit 28. Image number information 614 indicating that the image 616 is the 22^{nd} image and feeding information 618 indicating the second change direction (the direction for feeding the displayed image to the following image) and the second speed (high speed) are also displayed on the display unit 28.

FIG. 7 is a flowchart showing the leftward sliding operation processing (S310 in FIG. 3) performed by the digital camera 100 in detail. This processing is realized by the system control unit 50 by expanding a program recorded in the nonvolatile memory 56 in the system memory 52 and executing the program.

In S702, the system control unit 50 shifts (switches) the sliding operation state to a leftward sliding operation state.

In S704, the system control unit 50 determines whether or not the continuous image feeding state is in the OFF state. When the continuous image feeding state is in the OFF state, the processing advances to S706, and when the continuous image feeding state is not in the OFF state, the processing advances to S710.

In S706, the system control unit 50 alters the displayed image in the first change direction by a number of images corresponding to the sliding operation amount (image feeding performed in the first change direction in accordance with the sliding operation amount, or in other words the movement distance of the touch position during sliding).

In S708, the system control unit 50 stops counting the touch count time, counting of which was started in S304 of FIG. 3 or the like, initializes the touch count time, and starts counting the touch count time again.

In S710, the system control unit 50 determines whether or not the continuous image feeding state is in the low-speed image feeding state in the second change direction. When the continuous image feeding state is in the low-speed image feeding state in the second change direction, low-speed image feeding in the second change direction is stopped, and the processing advances to S712. When the continuous image feeding state is not in the low-speed image feeding state in the second change direction, the processing advances to S716.

In S712, the system control unit 50 shifts the continuous image feeding state to the low-speed image feeding state in the first change direction. In S714, the system control unit 50 performs low-speed image feeding in the first change direction. At this time, the speed of the low-speed image feeding in the first change direction is set at a third speed, which is lower than the second speed.

In S716, the system control unit 50 determines whether or not the continuous image feeding state is in the high-speed image feeding state in the second change direction. When the continuous image feeding state is in the high-speed image feeding state in the second change direction, high-speed image feeding in the second change direction is stopped, and the processing advances to S718. When the continuous image feeding state is not in the high-speed image feeding state in the second change direction, the leftward sliding operation processing is terminated.

In S718, the system control unit 50 shifts the continuous image feeding state to the high-speed image feeding state in the first change direction. In S720, the system control unit 50 performs high-speed image feeding in the first change direction. In other words, in this case, high-speed image feeding in the second change direction is switched to high-speed image feeding in the first change direction while the change speed remains at the second speed (the change direction is switched but the absolute value of the change speed is maintained).

FIG. 8 is a flowchart showing the rightward sliding operation processing (S314 in FIG. 3) performed by the digital camera 100 in detail. This processing is realized by the system control unit 50 by expanding a program recorded in the nonvolatile memory 56 in the system memory 52 and executing the program. Note that the processing of FIG. 8 differs from the processing of FIG. 7 only in that the operation direction and the change direction are respectively reversed and in all other respects is basically identical to the processing of FIG. 7.

In S802, the system control unit 50 shifts the sliding operation state to a rightward sliding operation state. The rightward sliding operation state is established after a rightward sliding operation is performed on the touch bar 82.

In S804, the system control unit 50 determines whether or not the continuous image feeding state is in the OFF state. When the continuous image feeding state is in the OFF state, the processing advances to S806, and when the continuous image feeding state is not in the OFF state, the processing advances to S810.

In S806, the system control unit 50 changes the displayed image in the second change direction by a number of images corresponding to the sliding operation amount (image feeding performed in the second change direction in accordance with the sliding operation amount).

In S808, the system control unit 50 stops counting the touch count time, counting of which was started in S304 of FIG. 3, S708 of FIG. 7, or the like, initializes the touch count time, and starts counting the touch count time again.

In S810, the system control unit 50 determines whether or not the continuous image feeding state is in the low-speed image feeding state in the first change direction. When the continuous image feeding state is in the low-speed image feeding state in the first change direction, low-speed image feeding in the first change direction is stopped, and the processing advances to S812. When the continuous image feeding state is not in the low-speed image feeding state in the first change direction, the processing advances to S816.

In S812, the system control unit 50 shifts the continuous image feeding state to the low-speed image feeding state in the second change direction. In S814, the system control unit 50 performs low-speed image feeding in the second change direction. At this time, the speed of the low-speed image feeding in the second change direction is set at the third speed.

In S816, the system control unit 50 determines whether or not the continuous image feeding state is in the high-speed image feeding state in the first change direction. When the continuous image feeding state is in the high-speed image feeding state in the first change direction, high-speed image feeding in the first change direction is stopped, and the processing advances to S818. When the continuous image feeding state is not in the high-speed image feeding state in the first change direction, the rightward sliding operation processing is terminated.

In S818, the system control unit 50 shifts the continuous image feeding state to the high-speed image feeding state in the second change direction. In S820, the system control unit 50 performs high-speed image feeding in the second change direction. At this time, the speed of the high-speed image feeding in the second change direction remains at the second speed.

Hence, according to the sliding operation processing of FIGS. 7 and 8, when a sliding operation performed on the touch bar 82 is detected before continuous image feeding is executed (in other words, when a touch-move is performed after a touch-down before the touch position has remained stationary for at least the threshold time), image feeding is performed in accordance with the sliding operation (S706 and S806). Note that in this embodiment, image feeding is performed in S706 and S806 by a steadily larger number of images (change amount) as the sliding operation amount increases, but image feeding may be performed by a number of fed images (1 image, for example) that is independent of the operation amount of the sliding operation.

Further, according to the sliding operation processing of FIGS. 7 and 8, when a sliding operation in the opposite direction to the operation direction corresponding to the current change direction is detected while low-speed image feeding is underway, the change direction is switched to the opposite direction to the current change direction, whereupon low-speed image feeding is continued. As is evident from the above description, the first change direction corresponds to the leftward direction (a leftward sliding operation) and the second change direction corresponds to the rightward direction (a rightward sliding operation). Similarly, according to the sliding operation processing of FIGS. 7 and 8, when a sliding operation in the opposite direction to the operation direction corresponding to the current change direction is detected while high-speed image feeding is underway, the change direction is switched to the opposite direction to the current change direction, whereupon high-speed image feeding is continued. When continuous image feeding is continued after switching the change direction, a large change in the speed of the image feeding may disturb the user. In this embodiment, when continuous image feeding is continued after switching the change direction, a switch from one of low-speed image feeding and high-speed image feeding to the other is not performed, and therefore a large change does not occur in the speed of the image feeding. As a result, the aforesaid disturbance to the user can be suppressed.

Furthermore, when continuous image feeding is continued, image feeding corresponding to the sliding operation performed on the touch bar 82 (S706 and S806) is thought to be unnecessary. Therefore, in the sliding operation processing of FIGS. 7 and 8, when a sliding operation is performed on the touch bar 82 while continuous image feeding is underway, image feeding is not performed in accordance with the sliding operation. Note, however, that the present invention is not limited to this configuration, and image feeding may be performed by a smaller number of images than in S706 and S806.

Note that the aforementioned third speed may be equal or different to the first speed. By setting the third speed to be equal to the first speed, a change in the image feeding speed while low-speed image feeding is underway can be eliminated, and as a result, the aforesaid disturbance to the user can be suppressed more effectively. By setting the third speed to be lower than the first speed, the likelihood of the images being fed too quickly during low-speed image feeding at the third speed can be reduced.

Using FIGS. 5A to 5D, an example of how low-speed image feeding in the first change direction is switched to low-speed image feeding in the second change direction will be described. The state transitions shown in FIGS. 5A to 5C are as described above.

FIG. 5D shows a state at a point where a finger 512 has been moved rightward from the state shown in FIG. 5C and thereafter, the touch has remained on the touch bar 82 continuously for 1 second without performing a sliding operation. In this embodiment, when a sliding operation is performed to move the finger 512 rightward from the state shown in FIG. 5C, the continuous image feeding that is currently underway is switched from low-speed image feeding in the first change direction to low-speed image feeding in the second change direction (S814 in FIG. 8). The low-speed image feeding in the second change direction is performed for as long as the touch remains on the touch bar 82 so that every 0.5 seconds, the displayed image is fed to the following image. Hence, in FIG. 5D, as a result of the low-speed image feeding in the second change direction, a second image 522 (=1 image×1 second/0.5 seconds) after the image 516 is displayed on the display unit 28. Image number information 520 indicating that the image 522 is the 9^{th} image and feeding information 524 indicating the second change direction (the direction for feeding the displayed image to the following image) and the third speed (low speed) are also displayed on the display unit 28. Since the change direction has been switched, the position and orientation of the feeding information 524 differ from those of the feeding information 518 shown in FIG. 5C, but since the type of continuous image feeding has not changed from low-speed image feeding, the pattern of the feeding information 524 is the same as that of the feeding information 518. Note that an example in which the third speed is equal to the first speed was described above, but when the third speed is different to the first speed, the pattern of the feeding information may be changed so that the difference can be recognized.

Hence, when a rightward sliding operation is detected while low-speed image feeding in the first change direction is underway, low-speed image feeding in the second change direction, rather than high-speed image feeding in the second change direction, is performed. As a result, the user can switch the change direction while checking the images (slowly feeding through the images).

Using FIGS. 6A to 6D, an example of how high-speed image feeding in the second change direction is switched to high-speed image feeding in the first change direction will be described. The state transitions shown in FIGS. 6A to 6C are as described above.

FIG. 6D shows a state at a point where a finger 606 has been moved leftward from the state shown in FIG. 6C and thereafter, the touch has remained on the touch bar 82 continuously for 1 second without performing a sliding operation. In this embodiment, when a sliding operation is performed to move the finger 606 leftward from the state shown in FIG. 6C, the continuous image feeding that is currently underway is switched from high-speed image feeding in the second change direction to high-speed image feeding in the first change direction (S720 in FIG. 7). The high-speed image feeding in the first change direction is performed for as long as the touch remains on the touch bar 82 so that every ⅙ of a second, the displayed image is returned to the preceding image. Hence, in FIG. 6D, as a result of the high-speed image feeding in the first change direction, a sixth image 622 (=3 images×1 second/(⅙ of a second)) before the image 616 is displayed on the display unit 28. Image number information 620 indicating that the image 622 is the 16^{th} image and feeding information 624 indicating the first change direction (the direction for returning the displayed image to the preceding image) and the second speed (high speed) are also displayed on the display unit 28. Since the change direction has been switched, the position and orientation of the feeding information 624 differ from those of the feeding information 618 shown in FIG. 6C, but since the type of continuous image feeding has not changed from high-speed image feeding, the pattern of the feeding information 624 is the same as that of the feeding information 618.

Hence, when a leftward sliding operation is detected while high-speed image feeding in the second change direction is underway, high-speed image feeding in the first change direction, rather than low-speed image feeding in the first change direction, is performed. As a result, the user can switch the change direction while quickly feeding through the images.

FIG. 9 is a flowchart showing the touch-up processing (S318 in FIG. 3) performed by the digital camera 100 in detail. This processing is realized by the system control unit 50 by expanding a program recorded in the nonvolatile memory 56 in the system memory 52 and executing the program.

In S902, the system control unit 50 determines whether or not the continuous image feeding state is in the OFF state. When the continuous image feeding state is in the OFF state, the processing advances to S906, and when the continuous image feeding state is not in the OFF state, the processing advances to S904.

In S904, the system control unit 50 stops the continuous image feeding that is currently underway.

In S906, the system control unit 50 determines whether or not the sliding operation state is in the OFF state. When the sliding operation state is in the OFF state, the processing advances to S908, and when the sliding operation state is not in the OFF state, the processing advances to S914.

In S908, the system control unit 50 determines whether or not the position being touched on the touch bar 82 is in the left-side region. When the position being touched is in the left-side region, the processing advances to S910, and when the position being touched is not in the left-side region, the processing advances to S912.

In S910, the system control unit 50 feeds the displayed image by 1 image in the first change direction. In S912, the system control unit 50 feeds the displayed image by 1 image in the second change direction. Hence, when a tap, which is an operation constituted only by a touch-down and a touch-up, is performed on the touch bar 82 without performing a sliding operation before continuous image feeding is executed, image feeding by a single image is performed. Meanwhile, when a touch-up from the touch bar 82 is performed while continuous image feeding is underway, the continuous image feeding is stopped without performing image feeding by a single image in response to the touch-up.

In S914, the system control unit 50 stops counting the touch count time and initializes the touch count time. In S916, the system control unit 50 shifts the sliding operation state to the OFF state. In S918, the system control unit 50 shifts the continuous image feeding state to the OFF state.

The present invention was described in detail above on the basis of preferred embodiments thereof, but the present invention is not limited to these specific embodiments and includes various other embodiments within a scope that does not depart from the spirit of the invention. Moreover, each of the embodiments described above merely illustrates one example of the present invention, and the embodiments may be combined as appropriate.

In the above embodiment, the present invention is applied to a case in which a parameter (the image number, the file number) specifying the image displayed during image feeding for switching the displayed image is changed, but the present invention is not limited thereto.

For example, the above embodiment may be applied using the playback speed of a moving image as the parameter. In this case, the above embodiment can be applied by associating the parameter with the frame number of a single moving image, for example, and control is performed as follows.
When, following a touch-down, the left-side region continues to be touched for at least the threshold time before a sliding operation is performed, the moving image is rewound at double speed for as long as the stationary touch is continued, whereby the displayed frame number is changed in a decreasing direction (the low-speed parameter change state of S410 and S412).
When, following a touch-down, the right-side region continues to be touched for at least the threshold time before a sliding operation is performed, the moving image is fast-forwarded at double speed for as long as the stationary touch is continued, whereby the displayed frame number is changed in an increasing direction (the low-speed parameter change state of S414 and S416).
When, following a touch-down, a sliding operation is performed before the threshold time elapses, whereupon the touch remains stationary in the left-side region without being released for at least the threshold time, the moving image is rewound at 5 times the normal speed for as long as the touch remains stationary thereafter, whereby the displayed frame number is changed in the decreasing direction (the high-speed parameter change state of S420 and S422).
When, following a touch-down, a sliding operation is performed before the threshold time elapses, whereupon the touch remains stationary in the right-side region without being released for at least the threshold time, the moving image is fast-forwarded at 5 times the normal speed for as long as the touch remains stationary thereafter, whereby the displayed frame number is changed in the increasing direction (the high-speed parameter change state of S424 and S426).
In response to a leftward sliding operation performed following a touch-down, the displayed frame is changed by a number of frames corresponding to the sliding operation amount (S706).
In response to a leftward sliding operation performed without releasing the touch while double-speed fast-forwarding is underway in response to a touch that continues for at least the threshold time, double-speed rewinding is performed for as long as the touch remains stationary thereafter (S712 and S714).
In response to a leftward sliding operation performed without releasing the touch while fast-forwarding is underway at 5 times the normal speed in response to a touch that continues for at least the threshold time, rewinding is performed at 5 times the normal speed (S718 and S720).
In response to a tap (an operation in which a touch-up is performed after a touch-down without performing a touch-move) in the left-side region in a state where playback is stopped, the displayed frame is rewound by 1 frame.

Further, the above embodiment is not limited to switching of moving images and still images, and may also be applied to operations for changing other setting parameters and control parameters. For example, the above embodiment may be applied using the sound volume output from a speaker as the parameter. In this case, the above embodiment can be applied by associating the parameter with the sound volume, for example, and control is performed as follows.
When, following a touch-down, the left-side region continues to be touched for at least the threshold time before a sliding operation is performed, the volume is reduced at a first change speed for as long as the stationary touch is continued (the low-speed parameter change state of S410 and S412).
When, following a touch-down, the right-side region continues to be touched for at least the threshold time before a sliding operation is performed, the volume is increased at the first change speed for as long as the stationary touch is continued (the low-speed parameter change state of S414 and S416).
When, following a touch-down, a sliding operation is performed before the threshold time elapses, whereupon the touch remains stationary in the left-side region without being released for at least the threshold time, the volume is reduced at a second change speed, which is higher than the first change speed, for as long as the stationary touch is continued thereafter (the high-speed parameter change state of S420 and S422).
When, following a touch-down, a sliding operation is performed before the threshold time elapses, whereupon the touch remains stationary in the right-side region without being released for at least the threshold time, the volume is increased at the second change speed, which is higher than the first change speed, for as long as the stationary touch is continued thereafter (the high-speed parameter change state of S424 and S426).
In response to a leftward sliding operation performed following a touch-down, the volume is reduced by an amount corresponding to the sliding operation amount (S706).
In response to a leftward sliding operation performed without releasing the touch while the volume is being increased at the first speed in response to a touch that continues for at least the threshold time, the volume is reduced at the first speed for as long as the stationary touch continues thereafter (S712 and S714).
In response to a leftward sliding operation performed without releasing the touch while the volume is being increased at the second speed in response to a touch that continues for at least the threshold time, the volume is reduced at the second speed for as long as the stationary touch continues thereafter (S718 and S720).
In response to a tap in the left-side region, the volume is reduced by a minimum change unit.

The present invention can be applied similarly to change actions having various other parameters as the change target, for example shooting parameters (shooting settings) such as the ISO sensitivity and the shutter speed, image processing parameters such as a luminance adjustment value and a color adjustment value, the date, hour, or second of a date/time setting, a selected target from an address book or the like, the displayed page of a written document, and so on.

Furthermore, in the above embodiment, an example in which the processing described in the flowcharts is performed in response to touch operations performed on the touch bar 82 was described, but the present invention is not limited thereto and may be applied to any operating member that can detect touch operations. Further, an embodiment in which sliding operations can be performed in the left-right direction was described as an example, but the present invention is not limited thereto and may also be applied to a configuration in which sliding operations can be performed in an up-down direction (whereby the first and second operation directions described above correspond to up or down) or a configuration in which rotary sliding operations can be performed in a clockwise/counterclockwise direction (whereby the first and second operation directions described above correspond to clockwise or counterclockwise). In other words, the present invention may also be applied to touch operations performed on a display item displayed on a bar or a circular display item displayed on the touch panel 70a, for example.

Moreover, the various types of control described above, which were described as being performed by the system control unit 50, may be executed using a single piece of hardware, or control of the entire apparatus may be executed by apportioning the processing among a plurality of pieces of hardware (a plurality of processors or circuits, for example). Furthermore, an example in which the present invention is applied to a digital camera (an imaging apparatus) was described in the above embodiment, but the present invention is not limited to this example and may be applied to any electronic device capable of detecting touch. For example, the present invention may be applied to a personal computer or a PDA, a mobile telephone terminal or a portable image viewer, a printer apparatus, a digital photo frame, a music player, a game machine, an electronic book reader, a video player, and so on. The present invention may also be applied to a display apparatus (including a projection apparatus), a tablet terminal, a smartphone, an AI speaker, a household appliance, an in-vehicle apparatus, a medical device, or the like.

According to the present disclosure, a specific change target can be changed to a desired target efficiently by a touch operation.

<Other Embodiments>

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-112662, filed on Jun. 18, 2019, which is hereby incorporated by reference herein in its entirety.

What is claimed is:

1. An electronic device comprising:
a touch detector configured to detect a touch operation performed on a touch operation surface; and
at least one memory and at least one processor which function as:
a control unit configured to
control so that before a specific touch operation is performed on the touch operation surface, a first action is executed to change a specific change target in a first change direction and at a first speed in accordance with continuation of touch on the touch operation surface,
control so that in a case where the specific touch operation is performed in a second operation direction before the first action is executed, in accordance with continuation of touch on the touch operation surface after that, a second action is executed to change the specific change target in a second change direction which is opposite to the first change direction, and at a second speed which is higher than the first speed, and
control so that in a case where the specific touch operation is performed in the second operation direction during execution of the first action, in accordance with continuation of touch on the touch operation surface after that, a third action is executed to change the specific change target in the second change direction and at a third speed which is lower than the second speed.

2. The electronic device according to claim 1, wherein the control unit controls so that in a case where the specific touch operation is performed in a first operation direction, which is opposite to the second operation direction, before the first action is executed, in accordance with continuation of touch on the touch operation surface after that, the specific change target is changed in the first change direction and at the second speed.

3. The electronic device according to claim 1, wherein the specific change target is a specific parameter.

4. The electronic device according to claim 3, wherein the specific parameter is one of a shooting parameter, an image processing parameter, a sound volume, a date, an hour, and a second.

5. The electronic device according to claim 1, wherein the specific change target is an image to be displayed.

6. The electronic device according to claim 1, wherein the specific touch operation is a sliding operation for touching the touch operation surface and then moving a touch position.

7. The electronic device according to claim 6, wherein a state before the specific touch operation is performed on the touch operation surface is a state in which a touch of the touch operation surface has begun, the touch has not been released, and the touch position of the touch has not moved by at least a predetermined distance.

8. The electronic device according to claim 1, wherein the control unit controls so that in a case where, during execution of an action at the second speed or the third speed, the specific touch operation is performed in an opposite operation direction to the operation direction corresponding to the change direction of the specific change target in the action, the action is continued after changing the change direction of the specific change target to an opposite direction.

9. The electronic device according to claim 1, wherein
the control unit controls so that
in a case where the specific touch operation is performed before executing an action at the first speed, an action at the second speed, and an action at the third speed, the specific change target is changed by a first change amount corresponding to an operation amount of the specific touch operation, and
in a case where the specific touch operation is performed during execution of the action at the first speed, the action at the second speed, or the action at the third speed, the specific change target is not changed in accordance with the operation amount of the specific touch operation.

10. The electronic device according to claim 1, wherein
the control unit controls so that
the specific change target is changed in accordance with a fact that a first region of the touch operation surface is touched, and then the touch is released from the touch operation surface without changing a touch position, and
the specific change target is not changed in accordance with a fact that the touch is released from the first region of the touch operation surface during execution of an action at the first speed, an action at the second speed, or an action at the third speed.

11. The electronic device according to claim 1, wherein
the control unit controls so that before the specific touch operation is performed on the touch operation surface,
the specific change target is changed in the first change direction and at the first speed in accordance with continuation of touch on a first region of the touch operation surface, and
the specific change target is changed in the second change direction and at the first speed in accordance with continuation of touch on a second region which is on a side in the second operation direction side from the first region.

12. The electronic device according to claim 1, wherein the third speed is equal to the first speed.

13. The electronic device according to claim 1, wherein the third speed is lower than the first speed.

14. A control method of an electronic device, comprising:
detecting a touch operation performed on a touch operation surface;
controlling so that before a specific touch operation is performed on the touch operation surface, a first action is executed to change a specific change target in a first change direction and at a first speed in accordance with continuation of touch on the touch operation surface;
controlling so that in a case where the specific touch operation is performed in a second operation direction before the first action is executed, in accordance with continuation of touch on the touch operation surface after that, a second action is executed to change the specific change target in a second change direction which is opposite to the first change direction, and at a second speed which is higher than the first speed; and
controlling so that in a case where the specific touch operation is performed in the second operation direction during execution of the first action, in accordance with continuation of touch on the touch operation surface after that, a third action is executed to change the specific change target in the second change direction and at a third speed which is lower than the second speed.

15. A non-transitory computer readable medium that stores a program, wherein the program causes a computer to execute a control method of an electronic device, the control method comprising:
detecting a touch operation performed on a touch operation surface;
controlling so that before a specific touch operation is performed on the touch operation surface, a first action is executed to change a specific change target in a first change direction and at a first speed in accordance with continuation of touch on the touch operation surface;
controlling so that in a case where the specific touch operation is performed in a second operation direction before the first action is executed, in accordance with continuation of touch on the touch operation surface after that, a second action is executed to change the specific change target in a second change direction which is opposite to the first change direction, and at a second speed which is higher than the first speed; and
controlling so that in a case where the specific touch operation is performed in the second operation direction during execution of the first action, in accordance with continuation of touch on the touch operation surface after that, a third action is executed to change the specific change target in the second change direction and at a third speed which is lower than the second speed.
